(19) United States
(12) Patent Application Publication
(10) Pub. No.: US 2008/0126479 A1
(43) Pub. Date: May 29, 2008

(54) METHOD, SERVER, TERMINAL AND SYSTEM FOR TRANSMITTING ELECTRONIC SERVICE GUIDE

(75) Inventors: Jie Zhang, Shenzhen (CN); Teng Shi, Shenzhen (CN); Chuxiong Zhang, Shenzhen (CN)

Correspondence Address: MARSHALL, GERSTEIN & BORUN LLP, 233 S. WACKER DRIVE, SUITE 6300, SEARS TOWER, CHICAGO, IL, 60606, US

(73) Assignee: Huawei Technologies Co., Ltd., Shenzhen (CN)

(21) Appl. No.: 11/956,821

(22) Filed: Dec. 14, 2007

Related U.S. Application Data
(63) Continuation of application No. PCT/CN2007/070018, filed on May 15, 2007.

(30) Foreign Application Priority Data
Aug. 22, 2006 (CN) 200610121786.8

(51) Int. Cl. G06F 15/16

(52) U.S. Cl. 709/203

(57) ABSTRACT

A method for transmitting an Electronic Service Guide (ESG) includes: sending, an ESG request message to a server; receiving information of to-be-transmitted fragments; requesting fragments required by a terminal from the server according to the information of the to-be-transmitted fragments; and receiving the required fragments sent from the server. Embodiments of the present invention further provide a system for transmitting an ESG, an ESG server and a terminal. With the solution of the present invention, a server may not be required to send a message including a large number of data to a terminal once, so that the reliability and efficiency of the transmission is improved. With solution of the present invention, it is avoided that the terminal receives invalid fragment information, so that resources are saved.

### FIELD OF THE INVENTION

The present invention relates to technologies of mobile video broadcast, and particularly, to methods an Electronic Service Guide (ESG) server, a terminal and a system for transmitting an ESG.

### BACKGROUND OF THE INVENTION

The service of mobile video broadcast is a novel mobile service. The mobile service may transmit video content to a mobile user via a broadcast network, a mobile communication network and a mobile terminal.

The technology of ESG is an important application layer technology in the mobile video broadcast. An ESG provides a user with a direct user interface and a visit guide. The user uses the direct user interface and the visit guide for viewing the material associated with various services, browsing a video channel, a playbill and a price list, selecting and purchasing one or more products listed on the price list, and logging on a website to browse web pages. The ESG is composed of various fragments based on their inherent logical relations. The information of one program is generally associated with multiple fragments. A server and a terminal both process ESG with a fragmented mechanism.

A user may acquire an ESG via multiple measures, one of which is to acquire the ESG through an interactive channel. In a conventional method, the measure of transmitting the ESG via the interactive channel is defined by TV-Anytime (TV-A) and BCAST protocol.

FIG. 1 is a simplified flowchart illustrating the signaling interaction for transmitting the ESG via an interactive channel according to a conventional method. As shown in FIG. 1, the procedure for the signaling interaction includes the following processes.

### Process 101: A terminal requests to obtain an ESG from an ESG server via an interactive channel.

### Process 102: The ESG server returns a response message to the terminal, and carries all fragments associated with the content of the ESG requested by the user in the response message.

Up to now, the procedure for obtaining the ESG via the interactive channel is finished.

As can be seen from the above technical solution, the conventional technology for transmitting the ESG has the following disadvantages.

When the content of the ESG is abundant, the ESG server is required to transmit a message including a large amount of data to the terminal once. Therefore, the probability of transmission error is increased greatly, and the reliability and the efficiency of the transmission are reduced.

Moreover, the processing capability of the terminal is greatly impacted if the response message returned from the ESG server is large. The ESG may be processed and displayed to the user merely when all content of the response message has been completely received, which leads to a long delay in the display and decreases processing efficiency.

In addition, a portion of fragments may be saved by the terminal. But, the terminal is still required to receive all fragments from the response message, which makes the terminal to perform unnecessary processing and wastes the resources of the terminal.

To sum up, the conventional technology for transmitting the ESG has worse reliability and lower transmission efficiency.

### SUMMARY

One embodiment of the present invention provides a method for transmitting an Electronic Service Guide (ESG). The method includes:

sending an ESG request message to a server;

receiving information of to-be-transmitted fragments;

requesting fragments required by a terminal from the server according to the information of the to-be-transmitted fragments; and

receiving the required fragments sent from the server.

Another embodiment of the present invention provides a method for transmitting an Electronic Service Guide, ESG. The method includes:

receiving an ESG request message sent from a terminal;

sending the information of to-be-transmitted fragments to the terminal; receiving a fragment request message sent from the terminal;

determining fragments required by the terminal; and

sending the fragments required by the terminal to the terminal.

Another embodiment of the present invention provides an Electronic Service Guide (ESG) server. The ESG server includes:

a first communicating module, configured to receive an ESG request message and a fragment request message;

a first request processing module, configured to search a first data storing module to obtain information of to-be-transmitted fragments according to the ESG request message, and send the information of the to-be-transmitted fragments via the first communicating module; and search the first data storing module to determine the fragments required by a terminal according to the fragment request message, and send the fragments required by the terminal via the first communicating module; and the first data storing module, configured to store the fragments required by the terminal.

Another embodiment of the present invention provides a terminal. The terminal includes:

a second request processing module, configured to generate an ESG request message and a fragment request message;

a second communicating module, configured to send the ESG request message and the fragment request message, and receive fragments required by the terminal and information of to-be-transmitted fragments;

a second fragment processing module, configured to search a second data storing module to determine the fragments required by the terminal according to the information of the to-be-transmitted fragments, and send the information of fragments required by the terminal to the second request processing module; and

the second data storing module, configured to store the fragments required by the terminal.

Another embodiment of the present invention provides a system for transmitting an Electronic Service Guide (ESG). The system includes:

a terminal, configured to send a fragment request message to request fragments required by the terminal and an ESG request message to request all ESG; and

the ESG server, configured to send the fragments required by the terminal and the ESG to the terminal.

As can be seen from above technical solution, in the technical solution disclosed by embodiments of the present invention, at first, a terminal sends an ESG request message to a server; and then, receives the information of all to-be-transmitted fragments, and requests the server for its required fragments according to the information of the to-be-transmitted fragments; at last, receives its required fragments which are sent from the server in several times. In this way, repetitious transmission avoids that the server sends a message including a large mount of data to the terminal once, so that the reliability and efficiency of the transmission is improved.

### BRIEF DESCRIPTION OF THE DRAWINGS

FIG. 1 is a simplified flowchart illustrating the signaling interaction for transmitting an ESG via an interactive channel according to a conventional method.

FIG. 2 is a schematic diagram illustrating the structure of a system for transmitting an ESG in accordance with a first embodiment of the present invention.

FIG. 3 is a simplified flowchart illustrating the signaling interaction for transmitting all ESG in accordance with all embodiment of the present invention.

FIG. 4 is a simplified flowchart illustrating a method for transmitting all ESG in accordance with a second embodiment of the present invention.

FIG. 5 is a simplified flowchart illustrating a method for transmitting an ESG in accordance with a fourth embodiment of the present invention.

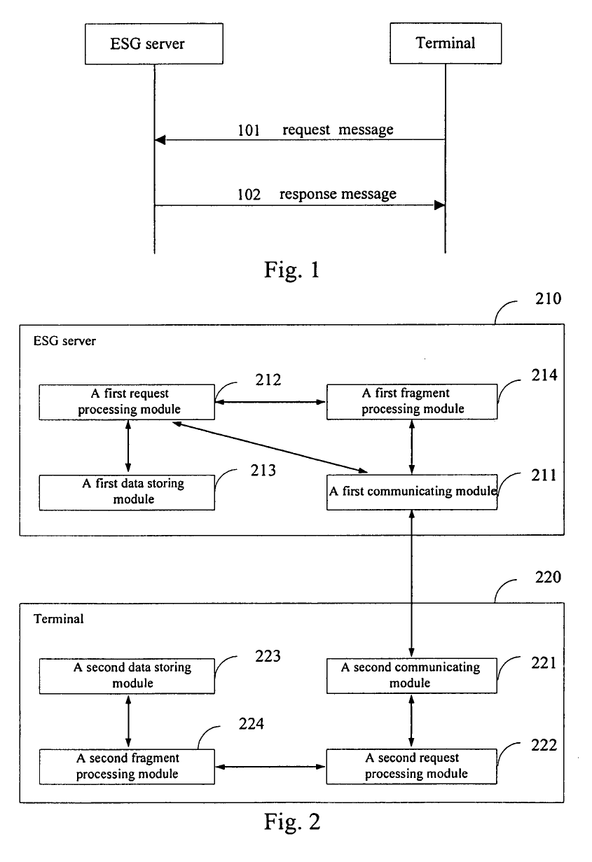

### DETAILED DESCRIPTION OF THE INVENTION

The present invention is further described as follows in detail with reference to the accompanying drawings as well as embodiments so as to make the technical solution and merits thereof more apparent.

FIG. 2 is a schematic diagram illustrating the structure a system for transmitting an ESG in accordance with a first embodiment of the present invention. Referring to FIG. 2, the system consists of an ESG server 210 and a terminal 220. The ESG server 210 consists of a first communicating module 211, a first request processing module 212, a first data storing module 213 and a first fragment processing module 214. The terminal 220 consists of a second communicating module 221, a second request processing module 222, a second data storing model 223 and a second fragment processing module 224.

The principle of the ESG system as shown in FIG. 2 is described as follows. The second request processing module 222 of the terminal 220 generates all ESG request message according to an ESG request of a user, and sends the ESG request message to the first communicating module 211 of ESG server 210 via the second communicating module 221.

The first communicating module 211 of the ESG server 210 sends the ESG request message received from the terminal 220 to the first request processing module 212.

The first request processing module 212 of the ESG server 210 searches the first data storing module 213 according to the ESG request message received from the first communicating module 211, determines to-be-transmitted fragments associated with the ESG requested by the terminal 220, and transmits the result of the searching to the first fragment processing module 214.

The first fragment processing module 214 of the ESG server 210 generates a list of to-be-transmitted fragments according to the result of the searching received from the first request processing module 212, takes the generated list of the to-be-transmitted fragments as the response message of the ESG request message, and sends the response message to the terminal 220 via the first communicating module 211.

The second communicating module 221 of the terminal 220 receives the response message sent from the ESG server 210, and sends the response message to the second fragment processing module 224 via the second request processing module 222.

The second fragment processing module 224 of the terminal 220 searches the second data storing module 223 of the terminal 220 according to the list of the to-be-transmitted fragments carried in the received response message, determines the fragments required by the terminal, and sends information of the fragments required by the terminal to the second request processing module 222.

The second request processing module 222 of the terminal 220 generates and sends a request message to the ESG server 210 according to the information of the fragments required by the terminal and received from the second fragment processing module 224.

The first communication processing module 211 of the ESG server 210 sends the request message carrying the information of the fragments to the first request processing module 212. The request message is received from terminal 220.

The first request processing module 212 of the ESG server 210 searches the first data storing module 213 according to the information of the fragments required by the terminal carried in the received request message, generates a response message according to the result of searching, and sends the response message to the terminal 220 via the first communicating module 211.

The principle of the ESG system as shown in FIG. 2 is described hereinabove. In the system shown in FIG. 2, the interaction between the ESG server 210 and the terminal 220 is generally implemented via a mobile communication network. The mobile communication network may include a Global System for Mobile communication (GSM) network, a General Packet Radio Service (GPRS) network or a Wideband Code Division Multiple Access (WCDMA) network. The message interaction between an ESG server and a terminal may be transmitted by such effective measure as Hypertext Transfer Protocol (HTTP), Wireless Application Protocol (WAP), short message or the like.

In embodiments of the present invention, a terminal may request a complete ESG while requesting an ESG server for an ESG, or request an ESG meeting a designated condition via a condition search.

After a terminal obtains a list of to-be-transmitted fragments, and determines its required fragments, embodiments of the present invention provide two methods for the terminal requesting an ESG server for the required fragments. One method is that the terminal sends multiple fragment request messages to the ESG server. The required fragments are designated in each fragment request message.

The other method is that the terminal merely sends one fragment request message to the ESG server to notify the ESG server of the information of fragments saved or not saved by the terminal and the number of the fragments that the terminal requires the ESG server to return. The ESG server determines the to-be-transmitted fragments to the terminal. And the terminal returns an acknowledgement message to the ESG server after receiving fragments sent from the ESG server each time.

Embodiments of the present invention further provide a method for transmitting an ESG while providing the ESC system shown in FIG. 2. The method for transmitting the ESG provided by the embodiment of the present invention is described as follows.

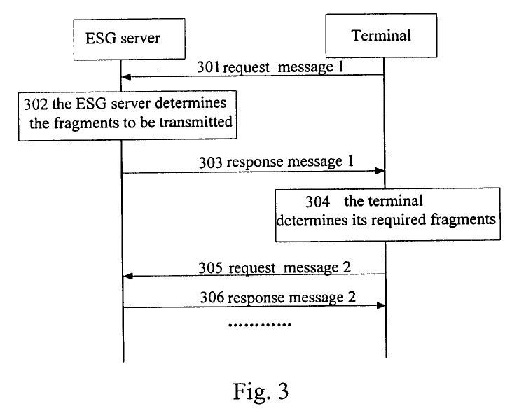

FIG. 3 is a simplified flowchart illustrating the signaling interaction for transmitting an ESG in accordance with an embodiment of the present invention. As shown in FIG. 3, the procedure of the signaling interaction includes following processes.

Process 301: A terminal sends an ESG request message to an ESG server via an interactive channel.

In this process, the terminal may send to the ESG server an ESG request message for acquiring a complete ESG or a condition search request message for acquiring an ESG meeting a condition.

Process 302: The ESG server determines to-be-transmitted fragments associated with the ESG according to the ESG requested by the terminal.

Process 303: The ESG server sends to the terminal a response message carrying the information of all to-be-transmitted fragments.

In this process, the ESG server may configure a list of the to-be-transmitted fragments according to the information of the to-be-transmitted fragments, and send the list of the to-be-transmitted fragments to the terminal.

Process 304: The terminal determines its required fragments according to the received information of the to-be-transmitted fragments.

Process 305: The terminal requests the ESG server for its required fragments.

Process 306: The ESG server sends the fragments required by the terminal to the terminal according to the request of the terminal.

Perform Process 305 to Process 306 repeatedly until all fragments requested by the terminal are transmitted, and terminate the procedure.

The procedure of the signaling interactive shown in FIG. 3 may be applied to various application scenes for transmitting an ESG. The method for transmitting an ESG is hereinafter described in detail with respect to three embodiments of the present invention.

The second embodiment:

In this embodiment, it is supposed that there is no ESG fragment saved in a terminal. The terminal requests an ESG server for a complete ESG. The terminal designates its required fragments each time while requesting the ESG server for the fragments according the information of the to-be-transmitted fragments returned by the ESG server.

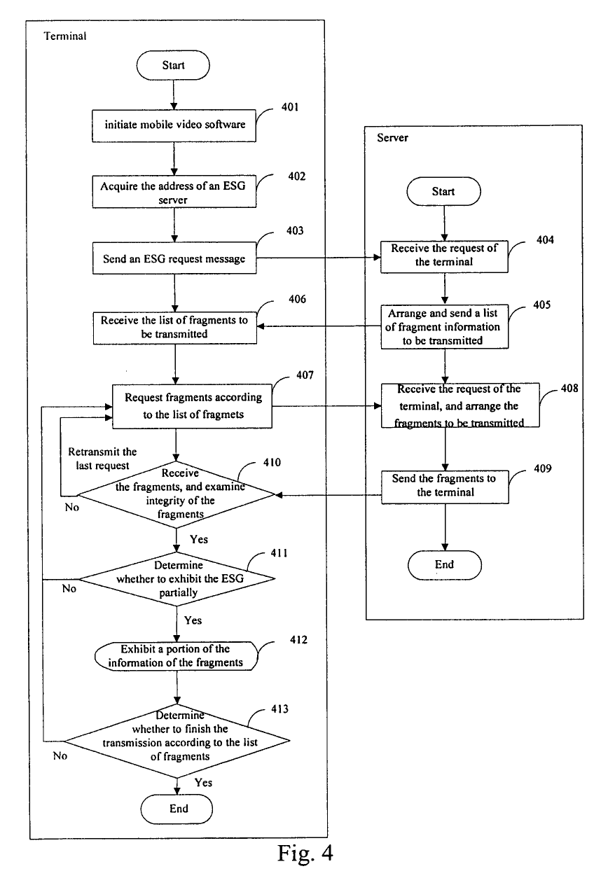

FIG. 4 is a simplified flowchart illustrating a method for transmitting an ESG in accordance with the second embodiment of the present invention. Referring to FIG. 4, the method includes the processing of a terminal and an ESG server. In particularly, the processing includes the following processes.

Process 401: A terminal initiates mobile video software.

Process 402: The terminal acquires the address of an ESG server.

Process 403: The terminal sends an ESG request message to the ESG server.

In this process, the terminal requests the ESG server for a complete ESG.

Process 404: The ESG server receives the request sent from terminal.

Process 405: The ESG server determines to-be-transmitted fragments according the request sent from the terminal, configures a list of to-be-transmitted fragments according to the information of the to-be-transmitted fragments and carries the list in a response message, and sends the response message to the terminal.

In this process, the list of the to-be-transmitted fragments configured by the ESG server includes at least one of the sum of the to-be-transmitted fragments, the list of fragment information and the maximum number of fragments that may be applied by the terminal each time.

The list of fragment information may include at least one of ID and version information of a to-be-transmitted fragment, starting position of the fragment in the message, existing time of the fragment, size of the fragment, code format of fragment and the detailed information of the fragment. When the ESG server determines to send all fragments to the terminal directly, the value of the field, i.e. the starting position of the fragment in the message, represents the starting position of each fragment in the field, i.e. the detailed information of the fragment.

In this embodiments it is supposed that the ESG requested by the terminal includes five fragments and the ESG server sends at most two fragments to the terminal each time. The ESG server may configure the list of fragment information according to the structure as shown in Table 1.

TABLE 1

| Field name | Value |
|---|---|
| FragmentSum | 5 |
| FragmentInfoList | |
| FragmentID[0] | 1 |
| FragmentVersion[0] | 1.0 |
| ValidFrom | 200607082300 |
| ValidTo | 200607082400 |
| FragmentSize | 675 |
| FragmentEncoding | UTF-8 |
| FragmentID[1] | 3 |
| FragmentVersion[1] | 1.0 |
| ValidFrom | 200607082300 |
| ValidTo | 200607082400 |
| FragmentSize | 676 |
| FragmentEncoding | UTF-8 |
| FragmentID[2] | 2 |
| FragmentVersion[2] | 1.0 |
| ValidFrom | 200607082300 |
| ValidTo | 200607082400 |
| FragmentSize | 679 |
| FragmentEncoding | UTF-8 |
| FragmentID[3] | 4 |
| FragmentVersion[3] | 1.0 |
| ValidFrom | 200607082300 |
| ValidTo | 200607082400 |
| FragmentSize | 678 |
| FragmentEncoding | UTF-8 |
| FragmentID[4] | 5 |
| FragmentVersion[4] | 1.0 |
| MaxRequestNum | 2 |

As shown in Table 1, the signification of each field is shown in Table 2.

TABLE 2

| Field name | Signification |
|---|---|
| FragmentSum | Fragment sum, the sum of to-be-transmitted fragments and |
| | determined according the request |
| FragmentInfoList | the list of fragment information consists of the |
| | information of multiple fragments |
| FragmentID[i] | Fragment ID which forms a list of fragment information |
| | with fragment version information |
| FragmentVersion[i] | Fragment version which forms a list of fragment |
| | information with the fragment ID |
| OffSet[i] | Indicating the starting position of the fragment in this |
| | message |
| ValidFrom[i] | The starting time of life time of a fragment, which is |
| | optional |
| ValidTo[i] | The ending time of life time of a fragment, which is |
| | optional |
| FragmentSize[i] | Fragment size, which is optional |
| FragmentEncoding[i] | Fragment code format, which is optional |
| Other | Other information associated with the fragments, which is optional |
| MaxRequestNum | The maximum number of fragments which may be applied |
| | by a terminal each time |
| FragmentList | A list of fragments consists of multiple fragments. The |
| | fragments may be directly sent when the ESG server |
| | determines that the content of the fragments is less and the |
| | fragments are not required to be transmitted in several times. |
| Fragment data[i] | Detailed fragment information, the content of which is the |
| | same as that of the conventional regulation |

The ESG server may arrange a list of fragment information according to the order of the fragment ID or other orders while configuring the list of the fragment information. Preferably, the list of fragment information may be configured by arranging the fragments associated with a program successively. The reasons of configuring the list of fragment information are as follows.

One program is generally associated with multiple fragments, and the fragment IDs associated with the program may be inconsecutive. For example, the fragment IDs associated with Program A may be 1 and 3, while the fragment IDs associated with Program B may be 2, 4 and 5. Therefore, an ESG server may arrange fragment information in a list according to the order easily processed by a terminal while configuring the list of fragment information. Referring to Table 1, in this embodiment, the fragments 1 and 3 associated with Program A are placed successively, while the fragments 2, 4 and 5 associated with Program B are placed successively. The fragment IDs are not simplified placed according to the digit order. In this way, if the terminal requests fragments according to the order of the list, the terminal may acquire all fragment information associated with Program A quickly and display the fragment information associated with Program A to a user.

In addition, in order to control the number of fragments requested by the terminal each time, the ESG server may carry the parameter of the maximum number of fragments which may be applied by the terminal each time (MaxRequestNum) in a response message sent to the terminal. The value of the MaxRequestNum may be set as a static value or may be dynamically adjusted by the ESG server according to its processing condition or the current network condition. For example, the server designates that the MaxRequestNum in this response message is 2. If the network condition and the processing condition of the ESG server are good, the ESG server may designate that the MaxRequestNum in the next response message is 10. The terminal may request fragments, the number of which is within the range of the parameter.

In embodiments of the present invention, the ESG server may determine whether to transmit the fragments in several times according to the content of the to-be-transmitted fragments. If the fragments are required to be transmitted in several times, the transmission may be performed according to the method in accordance with embodiments of the present invention; otherwise, the to-be-transmitted fragments are set in the detailed fragment information field of the FragmentList as shown in Table 2 and transmitted to the terminal.

Process 406: The terminal receives and saves the list of to-be-transmitted fragments from the ESG server.

Process 407: The terminal determines its required fragments according to the received list of the to-be-transmitted fragments, and sends a fragment request message to the ESG server.

In this process, the terminal may determine the fragments which are not saved by itself as the fragments required according to the fragment ID in the list of fragment information and its saved fragment information, or determine its saved fragments, of which the fragment version information does not accord with the fragment version information in the list of fragment information as the fragments required by itself according to fragment ID in the list of the fragments. In this embodiment, because the terminal does not save any ESG fragment, the fragments required by the terminal are all fragments in the list of fragment information.

The fragment request message may include at least one of the list of fragment in formation required by the terminal and the number of fragments applied from the ESG server in this message. The list of the fragments may include at least one of the fragment ID and fragment version information. The number of fragments applied from the ESG server in this message is unable to exceed the maximum number of fragments which may be applied by the terminal each time.

In this embodiment, because the terminal does not save any fragment, the terminal may request fragments 1 and 3 from the ESG server according to the order of the list of fragment information. The fragment request message sent from the terminal to the ESG server may be configured according to the structure as shown in Table 3:

TABLE 3

| Field name | Value |
|---|---|
| FragmentInfoList | |
| FragmentID[0] | 1 |
| FragmentVersion[0] | 1.0 |
| FragmentID[0] | 3 |
| FragmentVersion[0] | 1.0 |
| FragmentSum | 2 |

The signification of each field of Table 3 is shown in Table 4:

TABLE 4

| Field name | Signification |
|---|---|
| FragmentInfoList | the list of fragment information consists of the |
| | information of multiple fragments |
| FragmentID[i] | Fragment ID, which forms the list of fragment |
| | information with the fragment version information |
| FragmentVersion[i] | Fragment version, which forms the list of fragment |
| | information with the fragment ID |
| FragmentSum | The number of fragments applied from the ESG |
| | server in this message, which should be less than or |
| | equal to the MaxRequestNum shown in Table 2 |

In this process, the terminal may also request other fragments from the ESG server, but the number of Fragments requested is unable to exceed the parameter, i.e. the value of maximum number of fragments which may be applied by the terminal each time.

Process 408: The ESG server arranges the to-be-transmitted fragments according to the request of the terminal.

In this process, the ESG server determines whether the request carries the list of the fragments required by the terminal according to the request sent from the terminal. If the request carries the list of the fragments, it is indicated that the terminal has received its sent list of the to-be-transmitted fragments. The fragments listed in the list of the fragments are the fragments requested from the terminal to the ESG server. The ESG server arranges the to-be-transmitted fragments according to the request of terminal. If the request does not carry the list of the fragments requested by the terminal, it is indicated that this is the first request sent from the terminal to the ESG server or the list of the to-be-transmitted fragments sent from the ESG server is un-received. The ESG server should send the list of the to-be-transmitted fragments to the terminal according to Process 405

Process 409: The ESG server sends the fragments requested by the terminal to the terminal.

In this process, the message of the fragments sent from the ESG server to the terminal may include at least one of the number of fragments in the message, the list of fragment information included by the message, the list of the fragments, the maximum number of fragments which may be applied by the terminal each time and the list of invalid fragments

The list of fragment information included by the message includes at least one of ID of a fragment and version information, starting position of a fragment in the message and fragment size. The list of the fragments includes the detailed fragments. The list of invalid fragments includes at least one of the ID of an invalid fragment and version information of the invalid fragment. The fragments listed in the list of the invalid fragments are invalid fragments. Therefore, the terminal may request the fragments listed in the list of fragment information and not listed in the list of the invalid fragments from the ESG server according to the list of fragment information and the list of the invalid fragments.

In this embodiment, suppose that the ESG server determines that at most three fragments may be sent in each message according to the current condition or its own condition, the parameter, i.e. the maximum number of fragments which may be applied by the terminal each time, may be set as 3 in the response message sent to the terminals The response message for sending the information of the fragments from the ESG server to the terminal may be configured according to the structure as shown in Table 5.

TABLE 5

| Field name | Value |
|---|---|
| FragmentSum | 2 |
| FragmentInfoList | |
| FragmentID[0] | 1 |
| FragmentVersion[0] | 1.0 |
| OffSet[0] | 0X001 |
| Size[0] | 675 |
| FragmentID[1] | 3 |
| FragmentVersion[1] | 1.0 |
| OffSet[1] | 0X002 |
| Size[1] | 676 |
| FragmentList | |
| Fragment data[0] | Fragment content of fragment |
| | of which ID = 1 |
| Fragment data[1] | Fragment content of fragment |
| | of which ID = 3 |
| MaxRequestNum | 3 |

The signification of each field in Table 5 is shown in Table 6.

TABLE 6

| Field name | Signification |
|---|---|
| FragmentSum | Fragment sum, the number of the fragments included in the message |
| FragmentInfoList | The list of fragment information consists of the information of |
| | multiple fragments in the message. |
| FragmentID[i] | Fragment ID, which forms the list of fragment information with the |
| | fragment version information |
| FragmentVersion[i] | Fragment version, which forms the list of fragment information with |
| | fragment ID |
| OffSet[i] | Indicating the starting position of a fragment in this message |
| Size[i] | Fragment size |
| FragmentList | The list of the fragments consists of multiple fragments |
| Fragment data[i] | Detailed fragment, the content of which is the same as that of the |
| | conventional regulation |
| MaxRequestNum | The maximum number of fragments that may be applied by the |
| | terminal each time |
| InvalidFragmentInfoList | The list of invalid fragments which consists of the information of |
| | multiple fragments. The list of the invalid fragments indicates the |
| | invalid fragments in the list of fragment information within the time |
| | period from receiving the list of fragment information to requesting |
| | fragments by the terminal. The list is an optional parameter. |
| FragmentID[i] | Fragment ID, which forms the list of fragment information with the |
| | fragment version information |
| FragmentVersion[i] | Fragment version, which forms the list of fragment information |
| | together with fragment ID |

Process 410: The terminal receives the fragments sent from the ESC server, and examines the integrity and the correctness of the received fragments according to the fragment request message sent to the ESG server in Process 407. If the terminal receives its requested fragment completely and correctly, Process 411 is performed; otherwise, Process 407 is performed to retransmit the last request sent to the ESG server.

Process 411: Determine whether to exhibit the ESG fragments partially. If the ESG fragments may be partially exhibited, Process 412 is performed; otherwise, Process 407 is performed to continue requesting fragments.

Process 412: A portion of the ESG fragments is exhibited to the user.

Process 413: It is determined whether the transmission of all fragments required by the terminal has been finished according to the list of fragment information saved in Process 406 and the fragments saved by the terminal locally. If the transmission is finished, the procedure is terminated; otherwise, Process 407 is performed to continue requesting a fragment.

Up to now, the procedure for transmitting an ESG in accordance with the second embodiment of the present invention is implemented.

Referring to FIG. 4, the method for examining the integrity and correctness of the fragments, determining whether to exhibit the ESG fragments partially, and exhibiting the ESG fragments to the user is not further described.

As can be seen from the above embodiments, a terminal may request a complete ESG while requesting an ESG from an ESG server. The ESG server sends to the terminal the list of the to-be-transmitted fragments according to the request of the terminal. The list of the to-be-transmitted fragments includes the information of all to-be-transmitted fragments. The terminal requests designated fragments from the ESG server according to the list of the to-be-transmitted fragments received from the ESG server. The ESG server sends the fragments required by the terminal to the terminal in several times according to the request of the terminal. In this way, the fragments are transmitted to the terminal in several times, so that the transmission of a large number of data from the ESG server to the terminal once is avoided which improves the reliability and efficiency of the transmission.

The third embodiment:

In this embodiment, a terminal first sends a condition searching request to an ESG server to search an ESG meeting a condition. The terminal designates its required fragments each time while requesting fragments from the ESG server according to the list of the to-be-transmitted fragments. The list is returned by the ESG server.

The basic processes of the method for transmitting an ESG in this embodiment are identical with that as shown in FIG. 4 of the second embodiment. Therefore, refer to FIG. 4 for the flowchart of this embodiment. The method for transmitting an ESG in this embodiment includes the following processes.

From Process 401 to Process 402: A terminal initiates mobile video software, and acquires the address of an ESG server.

Process 403: The terminal sends a condition searching request to the ESG server to search program information meeting a specific condition.

Process 404: The ESG server receives the request of the terminal.

Process 405: The ESG server determines to-be-transmitted fragments according the condition searching request of the terminal, configures and sets a list of the to-be-transmitted fragments in a response message with the information of the to-be-transmitted fragments, and sends the response message to the terminal. In this embodiment, suppose that the to-be-transmitted fragments are identical with that of the second embodiment, the ESG server may configure a list of the to-be-transmitted fragments according to the method in Process 405 of the second embodiment, carry the configured list of the to-be-transmitted fragments in a response message, and send the response message to the terminal.

Process 406: The terminal receives and saves the list of the to-be-transmitted fragments from the ESG server.

Process 407: The terminal determines its required fragments according to the received list of the to-be-transmitted fragments, and sends a fragment request message to the ESG server. In this embodiment, suppose that the terminal determines that it has saved fragments 2, 4 and 5 by comparing the list of the fragments with the fragments saved by the terminal locally. Therefore, the terminal determines to request fragments 1 and 3 from the ESG server. In this process, the terminal may configure the fragment request message according to the method in Process 407 of the second embodiment.

Process 408: The ESG server arranges the to-be-transmitted fragments according, to the request of the terminal.

Process 409: The ESG server sends the fragments requested by the terminal to the terminal.

In this process, suppose that the ESG server determines that at most three fragments may be sent in each message according to the current network condition or its own condition, the parameter, i.e. the maximum number of fragments which may be applied by the terminal each time, may be set as 3 in the response message sent to the terminal. The ESG server determines that Fragment 1 is invalid according to certain reasons. Therefore, Fragment 1 is not required to be sent to the terminal. Therefore, the ESG server may carry the information indicating an invalid fragment, for example the invalid fragment ID and version information in the response message returned to the terminal. The response message of the fragment information sent from the ESG server to the terminal may be configured according to the structure as shown in Table 7.

TABLE 7

| Field name | Value |
|---|---|
| FragmentSum | 1 |
| FragmentInfoList | |
| FragmentID[0] | 3 |
| FragmentVersion[0] | 1.0 |
| OffSet[0] | 0X001 |
| Size[0] | 676 |
| FragmentList | |
| Fragment data[0] | The fragment content of the |
| | fragment with ID = 3 |
| MaxRequestNum | 3 |
| InvalidFragmentInfoList | |
| FragmentID[0] | 1 |
| FragmentVersion[3] | 1.0 |

The signification of each field of Table 7 is same as the signification of the corresponding field in Table 6. The Invalid Fragment Info List is the list of the information of invalid fragments. The Invalid Fragment Info List may be composed of the invalid Fragment ID and version information.

The operation for examining the integrity and correctness of fragments and exhibiting the ESG information partially in Processes 410˜413 of this embodiment is identical with that of the second embodiment. Refers to the relative processes described in the second embodiment. The relative processes will not be further described herein.

Up to now, the procedure for transmitting all ESG in accordance with the third embodiment of the present invention is implemented.

As can be seen from the above embodiments, a terminal may request an ESG meeting a designated condition via a condition searching request when requesting the ESG from an ESG server. The ESG server sends to the terminal a list of the to-be-transmitted fragments according to the request of terminal. The list of the to-be-transmitted fragments includes the information of all to-be-transmitted fragments. The terminal requests designated fragments from the ESG server according to the list of the to-be-transmitted fragments received from the ESG server. The ESG server sends the fragments required by the terminal to the terminal in several times according to the request of terminal. In this way, the fragments are transmitted to the terminal in several times, which avoids transmitting a large number of data to a terminal one time and improves the reliability and efficiency of the transmission.

In addition, in this embodiment, the ESG server carries the information of invalid fragments in the list of the to-be-transmitted fragments while sending the list of the to-be-transmitted fragments to the terminal. It is avoided that the terminal requests the invalid fragments in the list of the to-be-transmitted fragments, so that resources are saved.

The fourth embodiment:

In this embodiment, a terminal first requests a complete ESG from an ESG server. When the terminal requests fragments form the ESG server according to the list of to-be-transmitted fragments returned by the ESG server, the terminal merely sends one fragment request message to notify the ESG server of fragments saved by the terminal, the information of the fragments which are not saved by the terminal, or the number of fragments which the terminal requests the ESG server to return. The ESG server determines to-be-transmitted fragments to the terminal. After receiving a fragment sent by the ESG server each time, the terminal returns an acknowledgement message to the ESG server.

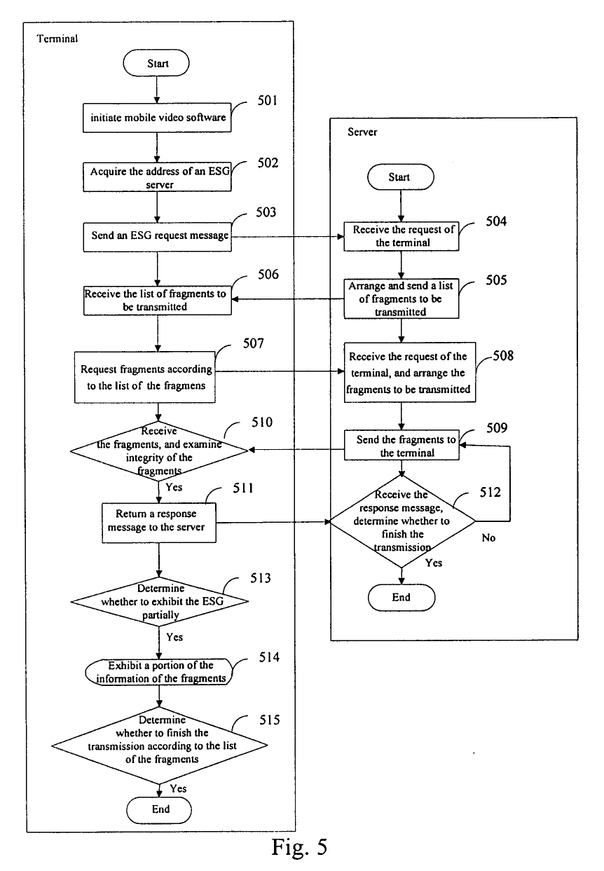

FIG. 5 is a simplified flowchart illustrating a method for transmitting an ESG in accordance with the fourth embodiment of the present invention. Referring to FIG. 5, the method includes the processing of a terminal and an ESG server. Particularly, the processing includes the following processes.

The operation of Processes 501˜504 is identical with the operation of Processes 401˜Step 404 in the second embodiment. Refer to relative processes described in the second embodiment. The relative processes will not be further described herein.

Process 505: The ESG server sends to the terminal a list of to-be-transmitted fragments. The list of the to-be-transmitted fragments carries a Session ID parameter to identify one terminal request.

Process 506: The terminal receives and saves the list of the to-be-transmitted fragments sent from the ESG server.

Process 507: The terminal sends a fragment request message to the ESG server according to the received list of the to-be-transmitted fragments. In this embodiment, when the terminal requests fragments from the ESG server, the terminal designates the number of fragments that the terminal requests the ESG server to return and the information of fragments saved by the terminal locally, and not designates its required fragments. Therefore, the fragment request message sent from the terminal to the ESG server may include at least one of session ID, the list of fragments required by the terminal, the number of fragments returned by the ESG server in this request, and the feedback of receiving condition.

The list of fragments required by the terminal may include at least one of message property parameter, fragment ID and version information.

There are two values of the message property parameter. The first value indicates that fragments listed in the list have been saved by the terminal locally, i.e. the fragments are not required to be issued by the ESG server. The second value indicates that fragments listed in the list have not been saved by the terminal locally, i.e. the fragments are required to be issued by the ESG server. The two values of the message property parameter may be distinguished by two digits respectively. For example, such two characters may be indicated by 1 and 2 respectively.

The feedback of receiving condition may be classified into three types. The first type indicates that the terminal has received the message sent from the ESG server successfully. The second type indicates that the last response message is required to be retransmitted by the ESG server. The third type indicates others. The three types may be distinguished with three digits respectively. For example, the three types may be indicated with 1, 2 and 3 respectively.

The fragment request message sent from the terminal to the ESG server may be configured according to the structure as shown in Table 8.

TABLE 8

| Field name | Signification |
|---|---|
| SessionID | Session ID indicating one request |
| FragmentInfoList | The list of fragment information consisting of the information of multiple |
| | fragments |
| FragmentInfoFlag | Indicating the character of the list of fragment information, for |
| | example, |
| | 1: Indicate that fragments listed in the list of fragment |
| | information have been saved by the terminal locally, i.e. the |
| | fragments are not required to be transmitted by the ESG server |
| | 2: Indicate that fragments listed in the list of fragment |
| | information have not been saved by the terminal locally, i.e. the |
| | fragments are required to be transmitted by the ESG server |
| FragmentID[i] | Fragment ID, which forms a list of fragment information |
| | together with the fragment version information |
| FragmentVersion[i] | Fragment version, which forms a list of fragment information |
| | together with fragment ID |
| FragmentSum | The number of fragments which are required to be returned by |
| | the ESG server in this request, the value of which should be less |
| | than or equal to MaxRequestNum. |
| STAUS | Feedback of receiving condition |
| | 1: Indicate that the terminal has received the message issued by |
| | the ESG server successfully |
| | 2: Indicate that it is necessary for the ESG server to retransmit the |
| | last transmitted message |
| | 3: Others |

Process 508: The ESG server arranges to-be-transmitted fragments according to the fragment request message received from the terminal.

Process 509: The ESG server sends the fragments requested by the terminal to the terminal. In this process, the ESG server carries a Session ID parameter in the response message of fragment information sent from the ESG server to the terminal, so as to indicate one request.

Process 510: The terminal examines the integrity and correctness of the received fragments. If the requested fragments have been received completely and correctly, Process 511 is performed.

Process 511: The terminal returns an acknowledgement message to the ESG server.

Process 512: The ESG server determines whether the transmission of ESG fragments has been completed after receiving the acknowledgement message returned by the terminal. If the transmission has been finished, the procedure is terminated; otherwise, the operation of transmitting fragments to the terminal according to the list of the fragments, in Process 509 is performed. Fragments which are not sent to the terminal in the list of fragment information are sent to the terminal.

Process 513: Determine whether to exhibit the information of ESG fragments partially. If the information of ESG fragments may be exhibited partially, the terminal proceeds to Process 514; otherwise, the terminal continues to wait for fragments sent by the ESG server.

Process 514: A portion of the information of ESG fragments is exhibited to a user.

Process 515: Determine whether the transmission of all fragments has been finished according to the list of fragments saved in Process 506 and fragments saved by the terminal locally. If the transmission has been finished, terminate the procedure; otherwise, continue to wait for fragments sent from the ESG server.

Referring to FIG. 5, the method for examining the integrity and correctness of fragments, determining whether to exhibit the information of ESG fragments partially, and exhibiting the information of ESG fragments to the user will not be further described.

Up to now, the procedure for transmitting an ESG in accordance with the fourth embodiment of the present invention is implemented.

As can be seen from the above embodiment, when a terminal requests an ESG from an ESG server, the ESG server sends to the terminal a list of to-be-transmitted fragments. The list of to-be-transmitted fragments includes the information of all to-be-transmitted fragments. The terminal requests designated fragments from the ESG server according to the list of the to-be-transmitted fragments. The ESG server sends the fragments required by the terminal to the terminal in several times according to the request of terminal. In this way, the fragments are transmitted to the terminal in several times, so that transmitting a large number of data from the ESG server to the terminal once is avoided, which improves the reliability and efficiency of the transmission

In addition, in this embodiment, the terminal merely sends one fragment request message to the ESG server, and designates the number of fragments which may be received by the terminal and the information of fragments saved by the terminal locally in the fragment request message. In this way, on the one hand, the terminal is not required to designate fragments each time, so as to simplify the processing of the terminal. On the other hand, because the order for transmitting fragments are managed by the ESG server, the ESG server may carry relative fragments in one message and send the message to the terminal, so that the terminal may exhibit the ESG to the user conveniently.

The above are merely embodiments of the present invention and are not for use in limiting the protection scope of the present invention. Any modification, equivalent replacement and improvement made under the spirit and principle of the present invention should be included in the protection scope of the present invention.

1. A method for transmitting an Electronic Service Guide, ESG, comprising:
sending an ESG request message to a server;
receiving information of to-be-transmitted fragments;
requesting fragments required by a terminal, from the server according to the information of the to-be-transmitted fragments; and
receiving the required fragments sent from the server.

2. The method of claim 1, wherein the receiving the required fragments sent from the server comprises:
receiving the required fragments which are sent from the server in several times.

3. The method of claim 2, wherein the information of the to-be-transmitted fragments comprises: a list of the to-be-transmitted fragments;
before the requesting fragments required by the terminal from the server, the method further comprises:
determining the required fragments according to the list of the to-be-transmitted fragments.

4. The method of claim 3, wherein the list of the to-be-transmitted fragments comprises at least a list of fragment information; and the list of fragment information comprises at least the IDs of the to-be-transmitted fragments; and
the determining the required fragments according to the list of the to-be-transmitted fragments comprises:
determining fragments which are not saved by the terminal as the required fragments according to the IDs of the to-be-transmitted fragments in the list of fragment in formation.

5. The method of claim 3, wherein the list of the to-be-transmitted fragments comprises at least a list of fragment information; and the list of fragment information comprises at least the version information of the to-be-transmitted fragments; and
the determining the required fragments according to the list of the to-be-transmitted fragments comprises:
determining fragments saved by the terminal as the required fragments, wherein
the version information of the fragments saved by the terminal does not accord with the version information of the to-be-transmitted fragments in the list of fragment information.

6. The method of claim 4, wherein the requesting fragments required by the terminal from the server comprises:
sending fragment request messages carrying the IDs of the required fragments to the server in several times; and
the receiving the required fragments which are sent from the server in several times comprises:
receiving fragments corresponding to the IDs of the fragments carried in the fragment request messages, wherein the fragments are sent from the server in several times.

7. The method of claim 6, wherein:
to-be-transmitted fragments which are associated with a program are set in the list of fragment information successively,
the order of the IDs of the fragments carried in the fragment request messages accords with the order of fragments set in the list of fragment information.

8. The method of claim 6, further comprising:
receiving at least one of IDs of the fragments, version information of the fragments, starting positions of the fragments, fragment size, number of fragments received at this time, maximum number of fragments which are applied by the terminal each time and a list of invalid fragments; wherein
the list of invalid fragments comprises at least one of IDs of invalid fragments and version information of the invalid fragments; and
the IDs of the fragments carried in the fragment request messages comprise the IDs of fragments listed in the list of fragment information and unlisted in the list of invalid fragments.

9. The method of claim 1, wherein the sending an ESG request message to a server comprises:
sending to the server a request message for acquiring a complete ESG or a condition searching request message.

10. The method of claim 1, further comprising:
requesting fragments from the server as determining that the received fragments are uncompleted or incorrect.

11. A method for transmitting an Electronic Service Guide, ES comprising:
receiving an ESG request message sent from a terminal;
sending the information of to-be-transmitted fragments to the terminal;
receiving a fragment request message sent from the terminal;
determining fragments required by the terminal; and
sending the fragments required by the terminal to the terminal.

12. The method of claim 11, wherein the sending the fragments required by the terminal to the terminal comprises:
sending the fragments required by the terminal to the terminal in several times.

13. The method of claim 12, wherein
the fragment request message carries the IDs of fragments which are not held by the terminal and a session ID, or carries the IDs of fragments which are saved by the terminal and the session ID, wherein the session ID is used for indicating a fragment request.

14. The method of claim 13, wherein the determining fragments required by the terminal comprises:
querying the information of the to-be-transmitted fragments; and
determining the fragments required by the terminal according to the session ID, and at least one of the IDs of fragments which are not held by the terminal and the IDs of fragments which are saved by the terminal.

15. The method of claim 13, wherein the fragment request message further carries the number of fragments that the terminal requires the server to return; and
the determining fragments required by the terminal comprises:
determining that the number of the fragments required by the terminal equals to the number of fragments carried in the fragment request message.

16. The method of claim 12, further comprising:
setting to-be-transmitted fragments which are associated with a program in the list of fragment information successively; wherein
sending the fragments required by the terminal to the terminal in several times comprises;
sending the fragments required by the terminal to the terminal in several times, wherein the order of the fragments required by the terminal accords with the order of the fragments set in the list of fragment information.

17. The method of claim 12, further comprising:
sending at least one of IDs of the fragments, version information of the fragments, starting positions of the fragments, fragment size, number of fragments received at this time.

18. The method of claim 11, wherein receiving an ESG request message sent from a terminal comprises:
receiving a request message for acquiring a complete ESG or a condition searching request message from the terminal.

19. An Electronic Service Guide, ESG, server, comprising:
a first communicating module, configured to receive an ESG request message and a fragment request message;
a first request processing module, configured to search a first data storing module to obtain information of to-be-transmitted fragments according to the ESG request message, and send the information of the to-be-transmitted fragments via the first communicating module; and search the first data storing module to determine the fragments required by a terminal according to the fragment request message, and send the fragments required by the terminal via the first communicating module; and
the first data storing module, configured to store the fragments required by the terminal.

20. The ESG server of claim 19, further comprising:
a first fragment processing module, configured to configure a list of the to-be-transmitted fragments according to the information of the to-be-transmitted fragments, and send the list of the to-be-transmitted fragments via the first communicating module.

21. The ESG server of claim 19, wherein
the first request processing module is further configured to send the fragments required by the terminal via the first communicating module in several times.

22. A terminal, comprising:
a second request processing module, configured to generate an ESG request message and a fragment request message;
a second communicating module, configured to send the ESG request message and the fragment request message, and receive fragments required by the terminal and information of to-be-transmitted fragments;
a second fragment processing module, configured to search a second data storing module to determine the fragments required by the terminal according to the information of the to-be-transmitted fragments, and send the information of fragments required by the terminal to the second request processing module; and
the second data storing module, configured to store the fragments required by the terminal.

23. The terminal of claim 22, wherein
the second communicating module is further configured to receive the fragments required by the terminal in several times.

24. A system for transmitting an Electronic Service Guide, ESG, comprising:
a terminal, configured to send a fragment request message to request fragments required by the terminal and an ESG request message to request an ESG; and
an ESG server, configured to send the fragments required by the terminal and the ESG to the terminal.

25. The system of claim 24, wherein the ESG server is further configured to send the fragments required by the terminal to the terminal in several times.

26. The system of claim 25, wherein
the ESG server is further configured to determine to-be-transmitted fragments according to the ESG request message, and send the information of the to-be-transmitted fragments to the terminal; and
the terminal is further configured to request fragments required by the terminal from the ESC server according to the information of the to-be-transmitted fragments.
